(19) United States
(12) Patent Application Publication
(10) Pub. No.: US 2002/0083848 A1
(43) Pub. Date: Jul. 4, 2002

(54) Length-dimensioning unit with clip module

(76) Inventors: Gerhard Mueller, Schemmerhofen (DE); Georg Staudenrausch, Biberach/Rissegg (DE)

Correspondence Address: MARSHALL, GERSTEIN & BORUN, 6300 SEARS TOWER, 233 SOUTH WACKER, CHICAGO, IL, 60606-6357, US

(21) Appl. No.: 09/986,223

(22) Filed: Oct. 22, 2001

(30) Foreign Application Priority Data
Nov. 8, 2000 (DE) 10055310.9

(51) Int. Cl. A23C 3/02; A23C 15/04; A22C 11/02; A23B 4/02

(52) U.S. Cl. 99/483; 99/494; 452/35

(57) ABSTRACT

The present invention relates to a sausage producing device comprising a charging pipe for stuffing sausage skins and a length-dimensioning unit for controlled removal of the stuffed sausage skins.

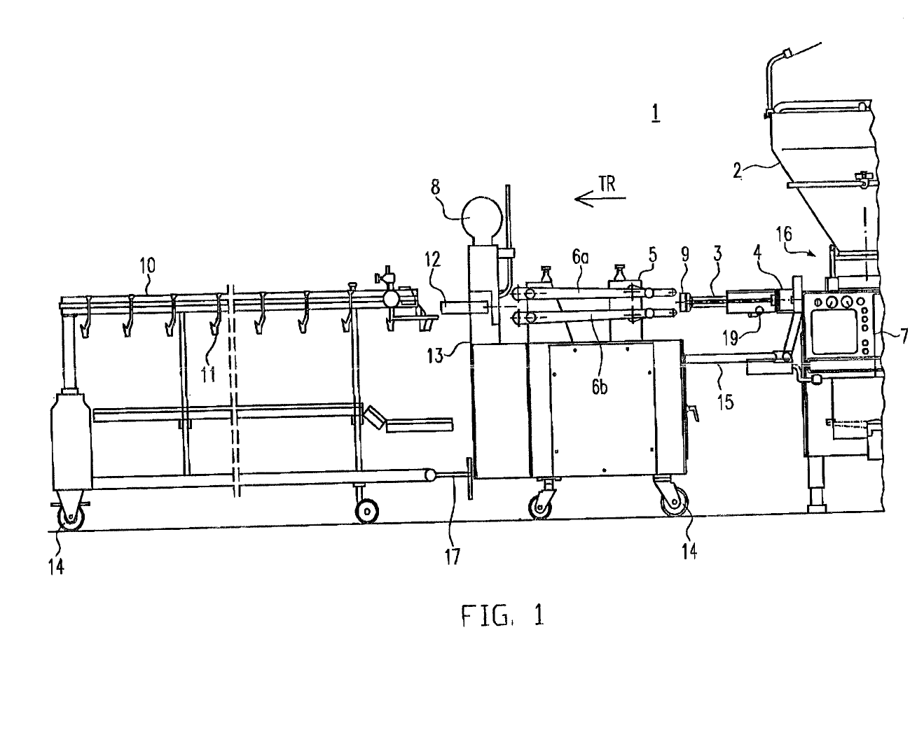

In order to permit sausages of identical lengths and identical volumes, especially also sausages sages whose sausage skin consists of a natural sausage casing, to be closed in a simple manner, a clip module for closing the stuffed sausage skins is arranged directly after said length-dimensioning unit, when seen in the direction of transport of the stuffed sausage skins.

The present invention relates to a device and a method for producing sausages as well as to a length-dimensioning unit for use in a sausage-producing device according to the generic clauses of claims 1, 10 and 20.

For automatic sausage production processes, stuffing machines are normally used. Such stuffing machines introduce sausage meat through a charging pipe into a sausage skin. For this purpose, the sausage skin is applied directly to the charging pipe in a concertina form or it is positioned in a respective sleeve which is pushed onto the charging pipe. Normally, a so-called sausage-skin brake or a brake ring is attached to the end of the charging pipe. When an amount of sausage meat corresponding to a single sausage has been ejected from the charging pipe, the sausage skin is twisted off with the aid of the brake ring mechanism and a twist off device. For pressing the sausage meat through the charging pipe, a suitable charging member is used, which feeds the sausage meat intermittently into the charging pipe. Such a stuffing machine is described e.g. in European patent No. 02 32 812.

In order to guarantee sausages containing a constant amount of sausage meat, the charging pipe is followed by a driven length-dimensioning unit. This length-dimensioning unit draws the sausage skin through the brake ring off the charging pipe. During the twist-off process, the length-dimensioning device prevents the already stuffed sausage from rotating together with the rotated part of the sausage skin.

By adjusting the removal rate during sausage stuffing relative to the stuffing material ejection rate, the length of the individual sausages cain be determined. The speed at which the stuffed sausage skin is transported away is adjusted in dependence upon a target stuffing material ejection rate. Such a method is described in German-Offenlegungsschrift 24 02 817.

It is also known to close the resultant sausage ends with the aid of so-called “Clip applicators”. Sausage closing by means of clip applicators is either effected by manually closing the sausages which have already been produced and twisted off said closing by hand requires a lot of time. It has also been suggested to provide the so-called clip applicator directly at the charging pipe. According to this method, the stuffed sausage skins are subdivided into individual sausages and closed by the application of clips. It has, however, turned out that the use of such clip applicators directly at the charging pipe entails the drawback that the volume and the outer contour of the individual sausages can be reproduced only to an insufficient extent, especially if a natural sausage casing is used as a sausage skin. On the one hand, neither the wall thickness nor the diameter is constant when natural sausage casings are used, so that different shapes of sausages may be obtained, and, or the other hand, the inconstant stretch-ability may cause a non-uniform outer contour if the stuffing material election curve is not uniform. The fact that, in the case of stuffed sausage skins, the stuffing material is additionally displaced when clips are being applied leads to deformations at the sausage ends.

Starting from this prior art, it is the object of the present invention to provide a device and a method for producing sausages, which can be used for closing the sausages in a simple manner and which are nevertheless suitable for producing sausages of identical lengths and identical volumes—in particular also sausages whose sausage skin consists of a natural sausage casing.

This object is achieved by the features of claims 1, 10 and 20.

In view of the fact that the stuffed sausage skins are first removed via a length-dimensioning unit in a controlled manner and given a predetermined shape, they can be subdivided into individual sausages very precisely at the end of the length-dimensioning unit via the clip module, said individual sausages having identical shapes and exactly identical volumes even in cases in which a natural sausage casing is used. This will lead to better weights in the case of cut-through sausages due to constant stuffing diameters, and better weights in the case of chains of sausages. especially as far as the first and the last portion is concerned. Due to the fact that the stuffed sausage skins are closed only after the length-dimensioning unit, when seen in the direction of transport, a higher ejection rate of the stuffing material is possible. In view of the arrangement of the clip module after the length-dimensioning unit, it is also possible to synchronize the filling and closing functions more effectively.

The charging pipe may additionally have associated therewith a twist-off unit so that the stuffed sausage skins can optionally be subdivided by twisting off It

It will be advantageous when the clip module includes a cutter so that the sausages can be closed and cut through in one unit in a space-saving manner. In accordance with an advantageous embodiment, the clip module also includes a loop former for the sausages to be produce. The clip module can be connected to El transfer unit by means of which the sausages produced are then advanced to a conveyor belt or a suspension unit.

The stuffing unit, the length-dimensioning unit and the clip module are advantageously connected via control lines to a control means for the sausage-producing device. The functions of the stuffing unit, the length-dimensioning unit and the clip module can therefore be executed in synchronism. Furthermore, also the transfer unit and the conveyor belt or the suspension unit can be connected to the control means of the sausage-producing device so that also the functions of these components car, be synchronized with the functions of the stuffing unit, the clip module and the length-dimensioning unit.

It will be advantageous when the dip module closes the stuffed sausage skins at two juxtaposed points; the cutter of the clip module will then cut through the stuffed sausage skins between these two points. The clip module can be controlled by the control means in such a way that cutting through is effected only after each n-th closure so as to obtain chains of sausages which comprise a specific number of sausages (n ∈IN).

If the stuffed sausage skin is subdivided prior to the length-dimensioning unit by twisting off, the clip module can close the stuffed sausage skins twice at the twist-off point.

Making reference to the only FIGURE, which shows a sausage-producing device according to the present invention, the present invention will be described in the following.

The FIGURE shows a schematic representation of an embodiment of the device according to the present invention. The stuffing unit 16 comprises a feed hopper 2 for the sausage meat and a charging pipe 3. The sausage meat is ejected from the charging pipe 3. For this purpose, a vane pump, not shown, can be provided in the interior of the stuffing unit 16. The charging pipe 3 can be rotated about its own axis with the aid of an optionally provided twist-off device 4 The end of the charging pipe 3 has attached thereto a brake ring housing 9 through which the sausage skin is drawn off with the aid of the length-dimensioning unit 5 while being filled by the charging pipe 3 The length-dimensioning unit 5 comprises two driven endless belts 6a and 6b which transport away the stuffed sausage skin between them.

The endless belts 6a, 6b of the length-dimensioning unit 5 are driven via a drive, which is not shown separately. In this embodiment, the length-dimensioning unit is a separate unit which stands on rollers 14 and which is therefore movable. The length-dimensioning unit 5 can be connected to the stuffing unit 16 through a fastening means 15. A clip module 8 is arranged on said length-dimensioning unit 5 via a schematically shown holder 13, said clip module 8 being arranged at the end constituting the rear end in the direction of transport TR of the sausages. The clip module 8 includes a clip applicator of the type used in the meat processing trade for producing closures for sausages In addition, the clip module 8 may comprise an integrated cutter for cutting through the individual sausages as well as a loop former. A transfer unit 12, which advances the closed sausages to a suspension unit 10 provided with a plurality of hooks 11, is located alter the clip module 8 when seen in the direction of transport TR. Alternatively the transfer unit 12 can also advance the finished sausages to a discharge means provided with a conveyor belt Also the suspension unit 10 is rests on rollers 14, and it is connected to the length-dimensioning unit through a fastening means 17.

The sausage-producing device additionally includes a control means 7. Through lines which are not shown, the control means 7 is connected to the stuffing unit 16, the length-dimensioning unit 5, the clip module 8 and the transfer unit 12. The functions of the stuffing unit 16, the length-dimensioning unit 5, the clip module 8 and the transfer unit 12 can be controlled and synchronized in this way. The control means 7 is integrated in the stuffing unit 16.

The operation of such a sausage-producing device will now be described in the following. The brake ring housing 9 is pivoted away from the charging pipe 3 with the aid of a pivot lever mechanism 19 in a manner known per se. A sausage skin in concertina form is attached to the charging pipe and the brake ring housing 9 is pivoted back to its former position. Sausage meat is filled into the device via a hopper 2. With the aid of the vane pump located in the stuffing unit 16, the sausage meat is pressed through the charging pipe 3 and fills the sausage skin. This has the effect that the sausage skin is drawn off the charging pipe 3. The length-dimensioning unit 5, which has been exactly aligned with the brake ring housing 9 via the rollers 14 and connected to the stuffing unit 16 via the fastening means 15, then seizes the sausage skin by means of its endless belts 6a and 6b. The endless belts 6a and 6b are driven such that they move assay from the charging pipe 3. For maintaining the necessary tension, the brake ring housing 9 has provided therein a brake ring which maintains the sausage skin in a slightly tensioned condition while it is being drawn off the charging pipe 3. The stuffing unit 16 continuously feeds the sausage skin with sausage meat for a plurality of sausages. The stuffed sausage skin is then advanced via the length-dimensioning unit 5 in the direction of transport along the arrow TR. A specific sausage shape is therefore obtained by adjusting the distance between the conveying belts 6a, 6b and the speed of said belts. The stuffed sausage skins transported in the length-dimensioning unit 5 are not yet subdivided. At the end of the length-dimensioning unit 5, the clip module 8 is arranged via a schematically shown holder 13; said clip module 8 subdivides the stuffed sausage skin into individual sausages and closes these sausages. In so doing, two metal clips can be clamped between two respective individual sausages. If necessary, the clip module can also include a loop former so that the individual sausages can be suspended with the aid of the inserted loops later on. The clip module 8 comprises in this case also a cutter which cuts through two neighbouring sausages between the metal clips after each n-th closing operation so as to produce chains of sausages comprising a specific number of sausages.

The individual sausages or chains of sausages comprising a specific number of sausages are then transferred to the transfer unit 12 in the direction of transport TR, said transfer unit 12 transferring the individual sausages or chains of sausages then to the hooks 11 of the suspension unit 10. Alternatively, the transfer unit 12 can also advance the individual sausages or chains of sausages to a discharge means provided with a conveyor belt As has already been described, the functions of the clip module 8, i.e. the closing, separating and loop-forming functions, must be synchronized with the functions of the length-dimensioning unit, e.g. the speed of the conveying belts 6a, 6b, and with the functions of the stuffing unit 16, e.g. the stuffing-material discharge amount and the stuffing-material discharge rate. It follows that an exact sausage length with precisely defined, reproducible stuffing volumes can be produced in accordance with the operating cycle of the clip module 8. Making use of servo-drive technology, the portioning performance can be improved. Also the transfer unit 12 is controlled via the control means 7 so that the sausages can be transported away continuously.

Alternatively to the above-described operation, the stuffing unit 16 can also eject through the charging pipe 3 the respective amount of sausage meat required for a single sausage, whereupon the charging pipe 3, together with the still unstuffed sausage skin material in concertina form, is rotated by the twist-off mechanism 4. Since the already stuffed sausage skin is held by the length-dimensioning unit 5 or rather by the endless belts 6a, 6b thereof, a constriction is formed, which leads to the formation of individual sausages. The clip module 8 can then close the individual sausages at the constriction by clamping two clips in position, e.g. on the left—and on the right-hand side of said constriction. The provision of the clip module 8 at the end of the length-dimensioning unit 5 constituting the rear end in the direction of transport permits the individual sausages to be closed in a simple and reproducible manner. In addition, a length-dimensioning unit 6 according to the present invention can also be combined with conventional stuffing units 16.

1. A sausage-producing device (1) comprising a stuffing unit (16) with a charging pipe (3) for stuffing sausage skins, and a length-dimensioning unit (5) for controlled removal of the stuffed sausage skins, characterized in that a clip module (8) for closing the stuffed sausage skins is arranged directly after said length-dimensioning unit (5) when seen in the direction of transport of the stuffed sausage skins.

2. A device according to claim 1, characterized in that the charging pipe (3) has associated therewith a twist-off unit (4).

3. A device according to claims 1 or 2,characterized in that the clip module (8) includes a cutter.

4. A device according to at least one of the preceding claims, characterized in that the clip module (8) includes a loop former.

5. A device according to at least one of the preceding claims, characterized in that, when seen in the direction of transport of the stuffed sausage skins, the clip module (8) is followed by a transfer unit (12).

6. A device according to at least one of the preceding claims, characterized in that, when seen in the direction of transport of the stuffed sausage skins, the transfer unit (12) is followed by a conveyor belt.

7. A device according to at least one of the preceding claims, characterized in that, when seen in the direction of transport of the stuffed sausage skins, the transfer unit (12) is followed by a suspension unit (10).

8. A device according to claim 1, characterized In that the stuffing unit (16), the length-dimensioning unit (5) and the clip module (6) are connected via control lines to a control means (7) for the sausage-producing device so that the functions of the length-dimensioning unit (5) and of the clip module (8) can be synchronized.

9. A device according to claims 1, 5 and 8, characterized in that the transfer unit (12) as well as the conveyor belt or the suspension unit are connected to the control means for the sausage-producing device via control lines so as to synchronize the functions of these components with the functions of the stuffing unit (16), of the length-dimensioning unit (5) and of the clip module (8).

10. A method of producing sausages comprising the steps of stuffing sausage skins via a charging pipe (3) and transporting them away in a controlled manner via a length-dimensioning unit (5), characterized in that the stuffed sausage skins are closed by a clip module 8) directly after the length-dimensioning unit (5).

11. A method according to claim 10, characterized in that the sausage skins are twisted off after stuffing and before they are transported away via the length-dimensioning unit (5).

12. A method according to claim 10 or 11, characterized In that the clip module (8) is controlled via a control means (7) in such a way that the stuffed sausage skins are closed synchronously with the stuffing of the sausage skins.

13. A method according to one of the claims 10 to 12, characterized in that the clip module (8) closes the stuffed sausage skins at two juxtaposed points.

14. A method according to claim 13, characterized in that the clip module (8) cuts through the stuffed sausage skins between these two points.

15. A method according to one of the claims 1 to 14, characterized in that cutting through is effected after each n-th closure so as to obtain chains of sausages which comprise a specific number of sausages (n ∈IN).

16. A method according to one of the claims 10 to 15, characterized in that the clip module (8) closes the stuffed sausage skins twice at the twist-off point.

17. A method according to at least one of the claims 10 to 16, characterized in that the stuffed sausage skins, which have been closed by the clip module (8), are advanced to a transfer unit (12).

18. A method according to at least one of the clams 11 to 17, characterized in that, when seen in tie direction of transport, the stuffed sausage skins are transferred to a conveyor belt or a suspension unit after the transfer unit (12).

19. A method according to at least one of the claims 10 to 18, characterized in that the functions of the clip module (18) take place in synchronism with the functions of the length-dimensioning unit and the transfer unit.

20. A length-dimensioning unit for use in a sausage-producing device (1) according to claim 1, characterized in that the length-dimensioning unit (5) includes a clip module (8) which is arranged at the rear end thereof, when seen in the direction of transport of the sausages.
